(19) United States
(12) Patent Application Publication
(10) Pub. No.: US 2016/0054017 A1
(43) Pub. Date: Feb. 25, 2016

(54) AIR CONDITIONING MANAGEMENT DEVICE, AIR CONDITIONING SYSTEM, AND PROGRAM

(71) Applicant: PANASONIC INTELLECTUAL PROPERTY MANAGEMENT CO., LTD., Osaka-shi, Osaka (JP)

(72) Inventor: Hayato TAKAHASHI, Hyogo (JP)

(21) Appl. No.: 14/781,305

(22) PCT Filed: Mar. 20, 2014
(86) PCT No.: PCT/JP2014/001631

§ 371 Date: Sep. 29, 2015

(30) Foreign Application Priority Data
Mar. 29, 2013 (JP) 2013-074549

(51) Int. Cl. F24F 11/00; G05B 15/02; F24F 7/007

(52) U.S. Cl. CPC F24F 11/006; F24F 7/007; F24F 11/0001; F24F 11/0012; F24F 11/0034; F24F 11/0076; G05B 15/02; F24F 2011/0002; F24F 2011/0006; F24F 2011/0013; F24F 2011/0035; F24F 2011/0036; F24F 2011/0061; F24F 2011/0068

(57) ABSTRACT

An air conditioning management device is configured to manage air-conditioning in a building. The air conditioning management device includes a storage unit, a selecting unit, and an execution unit. The storage unit is configured to store a first control content and a second control content. The first control content corresponds to a first scene in which no person is active in a specific space inside the building. The second control content corresponds to a second scene in which a person is active in the specific space. The execution unit is configured to execute an operational mode of operating the air conditioning adjustment system according to the first control content when the first scene is selected. The execution unit is configured to execute a notification mode of making a notification unit such as a display device report the second control content when the second scene is selected.

### TECHNICAL FIELD

The present invention relates to air conditioning management devices, air conditioning systems, and programs, and, more particularly, an air conditioning management device, an air conditioning system, and a program that are used to manage air-conditioning in a building.

### BACKGROUND ART

Conventionally, various kinds of technologies of cooling in a room are developed (see JP 2009-63225 A, for example, hereinafter referred to as “Document 1”).

In the technology described in Document 1, whether or not an outdoor air is sent in a room is determined by an indoor temperature being compared with an outdoor temperature. In the technology described in Document 1, when the indoor temperature is lower than the outdoor temperature, an opening for sending the outside air into the room is closed, and cooling to the indoor air is operated. On the other hand, when the indoor temperature is higher than the outdoor temperature, the cooling to the indoor air is stopped, the opening is opened, and then, the outdoor air can be sent in the room.

In the conventional technology described in Document 1, as described above, automatically, the opening is closed and the cooling to the indoor air is operated, and the opening is opened and the outdoor air is sent in the room.

On the other hand, comfortable temperature and comfortable air quality are different by persons or with times. For this reason, in the conventional technology described in Document 1, a person may be uncomfortable by sending the outdoor air in the building automatically also when a person exists in the room.

### SUMMARY OF INVENTION

The present invention has been made in the light of the above-mentioned problem, and it is an object of the present invention to provide an air conditioning management device, an air conditioning system, and a program, in which it is possible to prevent air quality and temperature from making a person in a building uncomfortable due to automatic control, and a person in the building can receive a support for performing air-conditioning, in a scene in which a person is active in a specific space inside the building.

An air conditioning management device according to an aspect of the present invention is configured to control an air conditioning adjustment system to manage air-conditioning in a building. The air conditioning adjustment system is disposed in the building and configured to adjust air in the building. The air conditioning management device includes a storage unit, a selecting unit, and an execution unit. The storage unit is configured to store a first control content and a second control content as a control content for operating the air conditioning adjustment system. The first control content corresponds to a first scene in which no person is active in a predetermined specific space inside the building. The second control content corresponds to a second scene in which a person is active in the predetermined specific space. The selecting unit is configured to alternatively select the first scene or the second scene. The execution unit is configured to execute an operational mode of operating the air conditioning adjustment system according to the first control content stored in the storage unit when the first scene is selected by the selecting unit. The execution unit is configured to execute a notification mode of making a notification unit report the second control content stored in the storage unit when the second scene is selected by the selecting unit.

In the air conditioning management device, the selecting unit is preferably configured to select, as the first scene, an absence scene in which no person exists in the building, or a sleep scene in which a person is sleeping in the building.

In the air conditioning management device, the selecting unit is preferably configured to select, as the second scene, a home presence scene in which a person exists and is active in the building.

In the air conditioning management device, the air conditioning adjustment system preferably includes a window opening/closing device and an air conditioner. The window opening/closing device is configured to control opening or closing of a window disposed in the building. The air conditioner is configured to perform air-conditioning in a predetermined space inside the building. The storage unit is preferably configured to store, as the second control content, a control content about opening and closing of the window and on and off of the air conditioner.

In the air conditioning management device, the air conditioning adjustment system preferably includes a skylight opening/closing device, a louver, and a ventilation fan. The skylight opening/closing device is configured to control opening or closing of a skylight disposed in the building. The louver is disposed in the building. The ventilation fan is configured to send air into the building from an outside of the building. The storage unit is preferably configured to store, as the first control content, a control content about opening and closing of the skylight, opening and closing of the louver, and on and off of the ventilation fan.

Preferably, the air conditioning management device further includes an information acquisition unit. The information acquisition unit is configured to acquire room-temperature information indicating a room temperature in the building, and outside-air-temperature information indicating outside air temperature outside the building. The execution unit is preferably configured to control the skylight opening/closing device, in the operational mode, so that the skylight is opened when a difference obtained by subtracting the outside air temperature from the room temperature is more than a predetermined threshold.

Preferably, the air conditioning management device further includes an information acquisition unit. The information acquisition unit is configured to acquire: room information indicating room temperature in the building; outside air temperature outside the building; and wind speed information indicating wind speed outside the building. The execution unit is preferably configured to operate the ventilation fan, in the operational mode, when the wind speed outside the building is equal to or less than a set value while a difference obtained by subtracting the outside air temperature from the room temperature is more than a predetermined threshold.

In the air conditioning management device, the air conditioning adjustment system preferably includes a louver and an air conditioner. The louver is disposed in the building. The air conditioner is configured to perform air-conditioning in a predetermined space inside the building. The execution unit is preferably configured to make the louver close when the air conditioner is in an on state. The execution unit is preferably configured to make the louver open when the air conditioner is in an off state.

Preferably, the air conditioning management device further includes a presence-information acquisition unit. The presence-information acquisition unit is configured to acquire presence information indicating whether or not a person exists in the building. The selecting unit is preferably configured to alternatively select the first scene or the second scene based on the presence information acquired by the presence-information acquisition unit.

Preferably, the air conditioning management device further includes an operation-information acquisition unit. The operation-information acquisition unit is configured to acquire, from an input device, operation information indicating an operation content to the input device. The input device is configured to receive an operation for selecting the first scene or the second scene. The selecting unit is preferably configured to alternatively select the first scene or the second scene based on the operation information acquired by the operation-information acquisition unit.

Preferably, the air conditioning management device further includes a presence-information acquisition unit, a first determining unit, and a second determining unit. The presence-information acquisition unit is configured to acquire presence information indicating whether or not a person exists in the building. The first determining unit is configured to determine whether or not a person exists in the building based on the presence information acquired by the presence-information acquisition unit. The second determining unit is configured to determine whether or not a person is active in the predetermined specific space inside the building based on the presence information acquired by the presence-information acquisition unit when the first determining unit determines that a person exists in the building. The selecting unit is preferably configured to select the absence scene when the first determining unit determines that no person exists in the building. The selecting unit is preferably configured to select the sleep scene when the second determining unit determines that no person is active in the predetermined specific space inside the building. The selecting unit is preferably configured to select the home presence scene when the second determining unit determines that a person is active in the predetermined specific space inside the building.

Preferably, the air conditioning management device further includes an operation-information acquisition unit. The operation-information acquisition unit is configured to acquire, from an input device, operation information indicating an operation content to the input device. The input device is configured to receive an operation for selecting the absence scene, the sleep scene, or the home presence scene. The selecting unit is preferably configured to select the home presence scene when the input device receives an operation for selecting the home presence scene. The selecting unit is preferably configured to select the sleep scene when the input device receives an operation for selecting the sleep scene. The selecting unit is preferably configured to select the absence scene when the input device receives an operation for selecting the absence scene.

An air conditioning system according to an aspect of the present invention includes: the air conditioning management device; and the air conditioning adjustment system that is an object to be controlled by the air conditioning management device.

A program according to an aspect of the present invention is a program for executing a computer that is used in order to control an air conditioning adjustment system to manage air-conditioning in a building. The air conditioning adjustment system is disposed in the building and configured to adjust air in the building. The program causes the computer to function as: a storage unit, a selecting unit, and an execution unit. The storage unit is configured to store a first control content and a second control content as a control content for operating the air conditioning adjustment system. The first control content corresponds to a first scene in which no person is active in a predetermined specific space inside the building. The second control content corresponds to a second scene in which a person is active in the predetermined specific space. The selecting unit is configured to alternatively select the first scene or the second scene. The execution unit is configured to execute an operational mode of operating the air conditioning adjustment system according to the first control content stored in the storage unit when the first scene is selected by the selecting unit. The execution unit is configured to execute a notification mode of making a notification unit report the second control content stored in the storage unit when the second scene is selected by the selecting unit. The aspect of the present invention is not limited to the program. The aspect of the present invention may be a computable-readable recording medium recording the program.

According to the present invention, in the scene in which no person is active in the specific space inside the building when a person is absent, for example, it is possible to set air-conditioning to be an ideal state by automatic control and gain ideal air quality and ideal temperature. On the other hand, according to the present invention, in the scene in which a person is active in the specific space inside the building, it is possible to prevent air quality and temperature from making a person in the building uncomfortable due to automatic control, and a person in the building can receive a support for performing air-conditioning.

### BRIEF DESCRIPTION OF DRAWINGS

Preferred embodiments of the present invention will now be described in further details. Other features and advantages of the present invention will become better understood with regard to the following detailed description and accompanying drawings where:

FIG. 1A is a block diagram showing a configuration of an air conditioning management device according to an embodiment;

FIG. 1B is a block diagram showing a configuration of an air conditioning system according to the embodiment;

FIG. 2 is a figure showing modes of the air conditioning management device according to the embodiment;

FIG. 3A is a flow chart showing operations of the air conditioning management device according to the embodiment;

FIG. 3B is a flow chart showing operations in a home presence mode of the air conditioning management device according to the embodiment;

FIG. 3C is a flow chart showing operations in a sleep mode of the air conditioning management device according to the embodiment;

FIG. 3D is a flow chart showing operations in an absence mode of the air conditioning management device according to the embodiment; and

FIG. 4 is a block diagram showing a configuration of s modification of the air conditioning system according to the embodiment.

### DESCRIPTION OF EMBODIMENTS

In an air conditioning system according to an embodiment described below, when no person is active in a specific space inside a dwelling unit (building), an air conditioning management device is configured to control an air conditioning adjustment system according to a first control content. On the other hand, when a person is active in the specific space inside the dwelling unit, the air conditioning management device is configured not to control the air conditioning adjustment system according to a second control content but to make a notification unit report the second control content.

Hereinafter, the air conditioning system according to the present embodiment will be described in detail with reference to drawings.

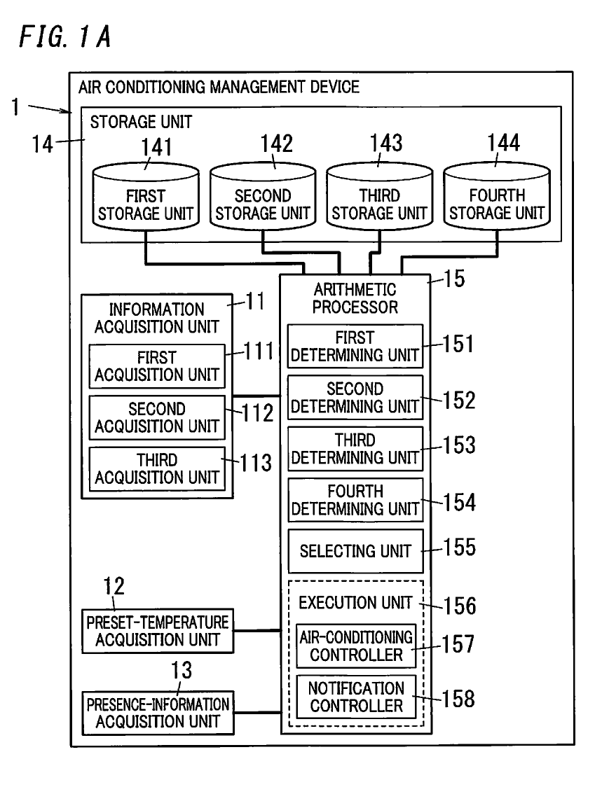

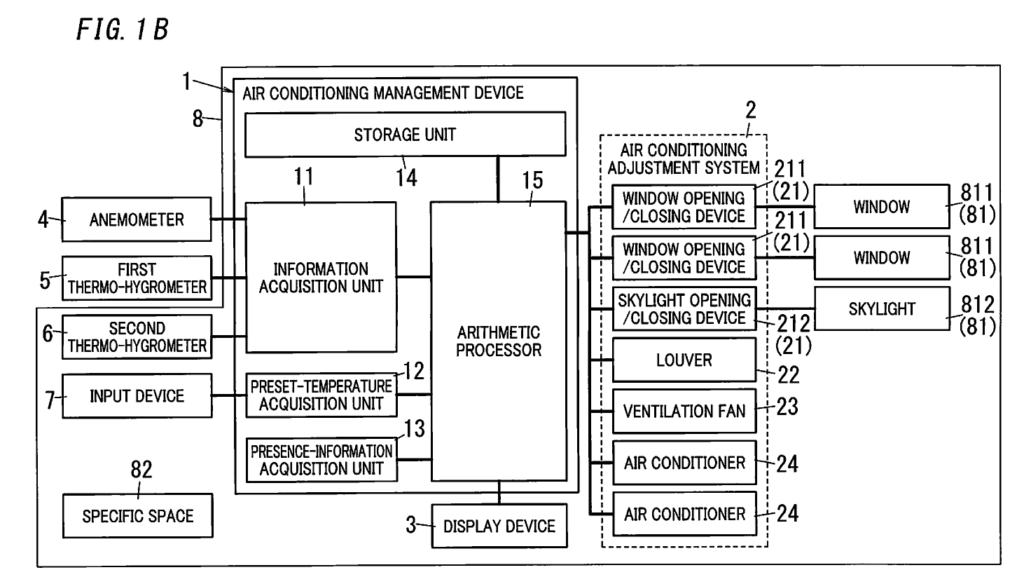

As shown in FIG. 1B, the air conditioning system according to the present embodiment includes an air conditioning management device 1 and an air conditioning adjustment system 2. The air conditioning system further includes a display device 3, an anemometer 4, a first thermo-hygrometer 5, a second thermo-hygrometer 6, and an input device 7.

Hereinafter, although the case where the air conditioning system is used for the general single house will be described as an example, the air conditioning system may be used for each dwelling unit in a collective housing for example, instead of the single house.

The air conditioning adjustment system 2 is the equipment that is an object to be monitored by the air conditioning management device 1. The air conditioning adjustment system 2 is configured to adjust air in the dwelling unit 8. The air conditioning adjustment system 2 includes a plurality of opening control devices 21, a louver 22, a ventilation fan 23, and a plurality of air conditioners 24. The number of the opening control devices 21, the number of the louver 22, the number of the ventilation fan 23, and the number of the air conditioners 24 are not limited to those in FIG. 1.

The opening control device 21 is configured to control opening and closing of an opening 81 in the dwelling unit (building) 8. Examples of the opening control device 21 include a window opening/closing device 211 and a skylight opening/closing device 212. The window opening/closing device 211 is configured to make a window 811, which is disposed on an outer wall of the dwelling unit 8 as an opening 81, open and close by operating a fitting such as a windowpane or window shutter. The skylight opening/closing device 212 is configured to make a skylight 812, which is disposed on a roof as the opening 81, open and close by operating a fitting such as skylight glass. The opening control device 21 is configured to be controlled by the air conditioning management device 1.

The louver 22 is disposed on a partition member of the dwelling unit 8 for ventilation.

The ventilation fan 23 is disposed in the dwelling unit 8 in order to send outside air into the dwelling unit 8 from the outside of the dwelling unit 8.

The air conditioner 24 is disposed in a predetermined space (for example, room) inside the dwelling unit 8. The air conditioner 24 is configured to perform air-conditioning in the predetermined space as an installed position of the air conditioner 24.

The display device 3 includes a liquid crystal display or an organic EL (Electro Luminescence) display, for example. The display device 3 is configured to display information acquired from the air conditioning management device 1. The display device 3 may be a television or an interphone master unit, for example. Alternatively, the display device 3 may be also a portable terminal unit such as a mobile phone, a smart phone, or a tablet computer.

The anemometer 4 is installed outside the dwelling unit 8. The anemometer 4 is configured to measure a direction (wind direction) and a speed (wind speed) of wind blowing outside the dwelling unit 8.

The first thermo-hygrometer 5 is installed outside the dwelling unit 8. The first thermo-hygrometer 5 is configured to measure air temperature outside the dwelling unit 8 (outside air temperature) and humidity outside the dwelling unit 8 (outside air humidity).

The second thermo-hygrometer 6 is installed in the dwelling unit 8. The second thermo-hygrometer 6 is configured to measure air temperature in the dwelling unit 8 (room temperature) and humidity in the dwelling unit 8 (room humidity).

The input device 7 is to be used, for example, for a person in the dwelling unit 8 (hereinafter referred to as a “person in the room”) inputting an instruction to the air conditioning management device 1. The input device 7 is configured to receive an input of the preset temperature (target temperature) in the dwelling unit 8, for example, by an input operation by a person in the room. The input device 7 may be also configured to receive inputs of various kinds of instructions other than the preset temperature.

Then, the air conditioning management device 1 will be described with reference to FIG. 1A. The air conditioning management device 1 is configured to monitor the air conditioning adjustment system 2 disposed in the dwelling unit 8 to manage air-conditioning in the dwelling unit 8. The air conditioning management device 1 is mainly constituted of a computer (also including a microcomputer) in which a CPU(s) (Central Processing Unit(s)) and a memory(-ies) are mounted, for example. The air conditioning management device 1 includes an information acquisition unit 11, a preset-temperature acquisition unit 12, a presence-information acquisition unit 13, a storage unit 14, and an arithmetic processor 15.

The information acquisition unit 11 is configured to acquire environmental information (environmental data). The environmental information (environmental data) includes weather information (weather data) and indoor environmental information (indoor environmental data). The weather information (weather data) includes wind pertinent information (wind pertinent data), outside-air-temperature information, and outside-air-humidity information. The wind pertinent information is information about wind blowing outside the dwelling unit 8, and includes information indicating a wind direction and a wind speed of the wind. The outside-air-temperature information indicates outside air temperature outside the dwelling unit 8. The outside-air-humidity information indicates outside air humidity outside the dwelling unit 8. The indoor environmental information includes room-temperature information and indoor-humidity information. The room-temperature information indicates room temperature in the dwelling unit 8. The indoor-humidity information indicates indoor humidity in the dwelling unit 8.

The information acquisition unit 11 includes a first acquisition unit (wind-pertinent-information acquisition unit) 111, a second acquisition unit (outside-air-temperature-and-humidity acquisition unit) 112, and a third acquisition unit (indoor-air-temperature-and-humidity acquisition unit) 113.

The first acquisition unit 111 includes an interface unit (not shown) for connecting with the anemometer 4. The first acquisition unit 111 is configured to acquire a measuring result of the anemometer 4, which is connected to the interface unit, from the anemometer 4. For example, the first acquisition unit 111 is configured to acquire the measuring result from the anemometer 4 at a cycle shorter than a switching interval for setting a ventilation state. Then, the first acquisition unit 111 is configured to select a wind direction with the highest frequency from distribution of wind directions acquired during the cycle from a time point when the previous ventilation state was set. The first acquisition unit 111 is configured to calculate an average value of wind speeds acquired during a predetermined period. Therefore, the first acquisition unit 111 can acquire, as the wind pertinent information, the selected wind direction and the calculated wind speed (average value). The first acquisition unit 111 may be configured to acquire the wind pertinent information from the anemometer 4 by wireless communication through a transmission medium of an electric wave instead of a cable.

The second acquisition unit 112 includes an interface unit (not shown) for connecting with the first thermo-hygrometer 5. The second acquisition unit 112 is configured to acquire a measuring result of the first thermo-hygrometer 5, which is connected to the interface unit, from the first thermo-hygrometer 5. That is, the second acquisition unit 112 is configured to acquire the outside air temperature and the outside air humidity from the first thermo-hygrometer 5. The second acquisition unit 112 may be configured to acquire the outside air temperature and the outside air humidity from the first thermo-hygrometer 5 by wireless communication through a transmission medium of an electric wave instead of a cable.

The third acquisition unit 113 includes an interface unit (not shown) for connecting with the second thermo-hygrometer 6. The third acquisition unit 113 is configured to acquire a measuring result of the second thermo-hygrometer 6, which is connected to the interface unit, from the second thermo-hygrometer 6. That is, the third acquisition unit 113 is configured to acquire the indoor environmental information from the second thermo-hygrometer 6. The third acquisition unit 113 may be configured to acquire the indoor environmental information from the second thermo-hygrometer 6 by wireless communication through a transmission medium of an electric wave instead of a cable.

The preset-temperature acquisition unit 12 includes an interface unit (not shown) for connecting with the input device 7. The preset-temperature acquisition unit 12 is configured to acquire the preset temperature inputted by an input operation to the input device 7, which is connected to the interface unit, from the input device 7. The preset-temperature acquisition unit 12 may be configured to acquire the preset temperature from the input device 7 by wireless communication through a transmission medium of an electric wave instead of a cable.

The presence-information acquisition unit 13 is configured to acquire presence information indicating whether or not a person exists in the dwelling unit 8. The presence-information acquisition unit 13 can be configured to acquire the presence information based on, for example, measuring results of human sensors, operation data of an apparatus, a life pattern, or an input by a user. The human sensors are disposed in various places that include a below-mentioned specific space 82 inside the dwelling unit 8.

The storage unit 14 includes a first storage unit (weather-information-history storage unit) 141, a second storage unit (indoor-environmental-information-history storage unit) 142, a third storage unit (control-log storage unit) 143, and a fourth storage unit (control-information storage unit) 144.

The first storage unit 141 is configured to store a history of the wind pertinent information that has ever been acquired by the first acquisition unit 111. Whenever the first acquisition unit 111 acquires the wind pertinent information, the wind pertinent information is stored in the first storage unit 141 by control of the arithmetic processor 15 so as to be associated with an acquisition date and an acquisition time. The first storage unit 141 is configured to store a history of the outside air temperature and the outside air humidity that have ever been acquired by the second acquisition unit 112. Whenever the second acquisition unit 112 acquires the outside air temperature and the outside air humidity, the outside air temperature and the outside air humidity are stored in the first storage unit 141 by control of the arithmetic processor 15 so as to be associated with an acquisition date and an acquisition time.

The second storage unit 142 is configured to store a history of the indoor environmental information that has ever been acquired by the third acquisition unit 113. Whenever the third acquisition unit 113 acquires the indoor environmental information, the indoor environmental information is stored in the second storage unit 142 by control of the arithmetic processor 15 so as to be associated with an acquisition date and an acquisition time.

The third storage unit 143 is configured to store, by control of the arithmetic processor 15, a history of control contents up to now, that is, the control log, to the air conditioning adjustment system 2. Whenever the air-conditioning controller 157 of the arithmetic processor 15 controls the air conditioning adjustment system 2 according to the control content of the air conditioning adjustment system 2, the control content is stored in the third storage unit 143 by control of the arithmetic processor 15 so as to be associated with a control date and a control time.

The fourth storage unit 144 is configured to store the control content for operating the air conditioning adjustment system 2 so as to be associated with a control condition for operating the air conditioning adjustment system 2 according to the control content.

The fourth storage unit 144 is configured to store a first control content and a second control content as a control content for operating the air conditioning adjustment system 2. The first control content corresponds to a first scene in which no person is active in the specific space 82 inside the dwelling unit 8. The second control content corresponds to a second scene in which a person is active in the specific space 82. The specific space 82 is a predetermined space.

In the present embodiment, the first scene is an absence scene in which no person exists in the dwelling unit 8 or a sleep scene in which a person is sleeping in the dwelling unit 8. The second scene is a home presence scene in which a person exists and is active in the dwelling unit 8.

Therefore, the fourth storage unit 144 is configured to store the control content corresponding to the home presence scene, the control content corresponding to the absence scene, and the control content corresponding to the sleep scene.

The fourth storage unit 144 is configured to store the control content about opening and closing of the window 811 and on and off of the air conditioner 24 as the control content corresponding to the home presence scene. The fourth storage unit 144 is configured to store the control content about opening and closing of the skylight 812, opening and closing of the louver 22, and on and off of the ventilation fan 23 as the control content corresponding to the absence scene. The fourth storage unit 144 is configured to store the control content about opening and closing of the skylight 812, opening and closing of the louver 22, on and off of the ventilation fan 23, and on and off of the air conditioner 24 as the control content corresponding to the sleep scene.

The arithmetic processor 15 includes a first determining unit 151, a second determining unit 152, a third determining unit 153, a fourth determining unit 154, a selecting unit 155, and an execution unit 156. The arithmetic processor 15 includes, as a main component, the CPU(s) mounted in the computer. The arithmetic processor 15 is configured to execute various programs to perform various processes. The various programs are stored in the storage unit 14.

The first determining unit 151 is configured to determine whether or not a person exists in the dwelling unit 8 based on the presence information acquired by the presence-information acquisition unit 13. When a person is detected in any space (including the specific space 82) inside the dwelling unit 8, the first determining unit 151 is configured to determine that a person exists in the dwelling unit 8. On the other hand, when no person is detected in all of the space inside the dwelling unit 8, the first determining unit 151 is configured to determine that no person exists in the dwelling unit 8.

The second determining unit 152 is configured to determine, when the first determining unit 151 determines that a person exists in the dwelling unit 8, whether or not a person is active in the specific space 82 inside the dwelling unit 8 based on the presence information acquired by the presence-information acquisition unit 13. For example, when a person is detected in a living room, for example, the second determining unit 152 is configured to determine that a person is active in the specific space 82 inside the dwelling unit 8. On the other hand, when a person is detected only in a bedroom, the second determining unit 152 is configured to determine that no person is active in the specific space 82 inside the dwelling unit 8.

The third determining unit 153 is configure to receive, from the storage unit 14, the outside-air-temperature information and the room-temperature information that are acquired by the information acquisition unit 11 and stored in the storage unit 14. The third determining unit 153 is configured to determine whether or not the difference (T1−T2) obtained by subtracting the outside air temperature T2 from the room temperature T1 is more than a first threshold δ1. First, the third determining unit 153 is configured to compare the room temperature T1 and the outside air temperature T2 acquired by the information acquisition unit 11. Then, the third determining unit 153 is configured to determine whether or not the difference (T1−T2) obtained by subtracting the outside air temperature T2 from the room temperature T1 is more than the first threshold δ1. The third determining unit 153 is configured to determine whether or not the difference (T1−T2) is more than a second threshold δ2. The third determining unit 153 is configured to determine whether or not the difference (T1−T2) is more than a third threshold δ3. The first threshold δ1, the second threshold δ2, and the third threshold δ3 may be different values or may be the same values. Alternatively, any two of them may be the same values.

The fourth determining unit 154 is configured to determine whether or not the wind speed V1 is equal to or less than a fourth threshold δ4 based on the wind speed information acquired by the information acquisition unit 11.

The selecting unit 155 is configured to alternatively select the first scene and the second scene based on the presence information acquired by the presence-information acquisition unit 13. That is, the selecting unit 155 is configured to select the absence scene or the sleep scene as the first scene, and select the home presence scene as the second scene. First, when the first determining unit 151 determines that no person exists in the dwelling unit 8, the selecting unit 155 is configured to select the absence scene. When the second determining unit 152 determines that no person is active in the specific space 82 inside the dwelling unit 8, the selecting unit 155 is configured to select the sleep scene. On the other hand, when the second determining unit 152 determines that a person is active in the specific space 82 inside the dwelling unit 8, the selecting unit 155 is configured to select the home presence scene.

The execution unit 156 is configured to execute the operational mode when the first scene is selected by the selecting unit 155. The execution unit 156 is configured to execute the notification mode when the second scene is selected by the selecting unit 155. The operational mode is a mode of operating the air conditioning adjustment system 2 according to the first control content stored in the storage unit 14. The notification mode is a mode of making the display device (notification unit) 3 report the second control content stored in the storage unit 14.

In the present embodiment, Example of the notification mode includes a home presence mode in which the display device 3 is made to report the control content corresponding to the home presence scene. Examples of the operational mode include an absence mode of operating the air conditioning adjustment system 2 according to the control content corresponding to the absence scene, and a sleep mode of operating the air conditioning adjustment system 2 according to the control content corresponding to the sleep scene. Example of the operational mode may include a scene in which a person exists in another space (a space other than the specific space 82) when activity place of a person in the dwelling unit 8 is limited to the specific space 82, in addition to the absence mode and the sleep mode.

The execution unit 156 includes an air-conditioning controller 157 and a notification controller 158. In the present embodiment, the air-conditioning controller 157 is configured to operate at the time of the absence mode and the sleep mode as the operational mode. The notification controller 158 is configured to operate at the time of the home presence mode as the notification mode.

The air-conditioning controller 157 is configured to control the air conditioning adjustment system 2 according to the control content and control condition that are stored in the storage unit 14. The air conditioning adjustment system 2 works according to control of the air-conditioning controller 157.

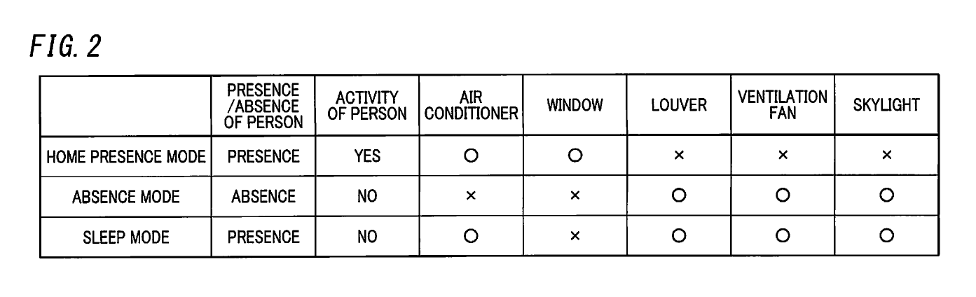

In the present embodiment, as shown in FIG. 2, the group of the apparatuses as the object to be controlled in the absence mode is different from that in the sleep mode. In the absence mode, the air-conditioning controller 157 is configured to control the louver 22, the ventilation fan 23, and the skylight opening/closing device 212 that opens and closes the skylight 812. In the sleep mode, the air-conditioning controller 157 is configured to control the louver 22, the ventilation fan 23, the skylight opening/closing device 212 that opens and closes the skylight 812, and the air conditioner 24. In the absence mode and the sleep mode shown in FIG. 2, each symbol “0” indicates a device that is an object to be controlled. each symbol “X” is a device that is an object not to be controlled.

In the sleep mode, when the third determining unit 153 determines that the difference (T1−T2) obtained by subtracting the outside air temperature T2 from the room temperature T1 is more than the second threshold δ2, the air-conditioning controller 157 is configured to control the skylight opening/closing device 212 so that the skylight 812 is opened, and to turn off the air conditioner 24. On the other hand, when the third determining unit 153 determines that the difference (T1−T2) is equal to or less than the second threshold δ2, the air-conditioning controller 157 is configured to control the skylight opening/closing device 212 to close the skylight 812, and to turn on the air conditioner 24.

In the sleep mode, when the third determining unit 153 determines that the difference (T1−T2) obtained by subtracting the outside air temperature T2 from the room temperature T1 is more than the third threshold δ3, the air-conditioning controller 157 is configured to make the louver 22 open and turn off the air conditioner 24. On the other hand, when the third determining unit 153 determines that the difference (T1−T2) is equal to or less than the third threshold δ3, the air-conditioning controller 157 is configured to close the louver 22 and turn on the air conditioner 24.

In the sleep mode, the air conditioner 24 as the object to be controlled is an air conditioner installed in the bedroom inside the dwelling unit 8, that is, an air conditioner configured to perform air-conditioning in the bedroom, for example.

In the absence mode, the air-conditioning controller 157 is configured to control the skylight opening/closing device 212 to open the skylight 812 when the third determining unit 153 determines that the difference (T1−T2) obtained by subtracting the outside air temperature T2 from the room temperature T1 is more than the second threshold δ2. On the other hand, when the third determining unit 153 determines that the difference (T1−T2) is equal to or less than the second threshold δ2, the air-conditioning controller 157 is configured to control the skylight opening/closing device 212 to close the skylight 812.

In the absence mode, the air-conditioning controller 157 is configured to open the louver 22 when the third determining unit 153 determines that the difference (T1−T2) obtained by subtracting the outside air temperature T2 from the room temperature T1 is more than the third threshold δ3. On the other hand, when the third determining unit 153 determines that the difference (T1−T2) is equal to or less than the third threshold δ3, the air-conditioning controller 157 is configured to close the louver 22.

In the absence mode and the sleep mode, the air-conditioning controller 157 is configured to operate the ventilation fan 23 when the fourth determining unit 154 determines that the wind speed V1 is equal to or less than the fourth threshold δ4.

The notification controller 158 is configured to make the display device (notification unit) 3 report the second control content stored in the storage unit 14 in the notification mode. In the present embodiment, as shown in FIG. 2, the notification controller 158 is configured to make the display device 3 report the control content about the air conditioner 24 and the window opening/closing device 211 configured to open or close the window 811 in the home presence mode. The display device 3 is configured to acquire the control content of the air conditioning adjustment system 2 from the notification controller 158, and display (report) the control content. In the home presence mode shown in FIG. 2, each symbol “0” indicates a device of which control content is informed by the display device 3. Each symbol “X” is a device of which control content is not informed by the display device 3.

In the home presence mode, the notification controller 158 is configured to make the display device 3 report the control content for controlling the window opening/closing device 211 to open the window 811, and the control content for turning off the air conditioner 24 when the third determining unit 153 determines that the difference (T1−T2) obtained by subtracting the outside air temperature T2 from the room temperature T1 is more than the first threshold δ1. On the other hand, when the third determining unit 153 determines that the difference (T1−T2) is equal to or less than the first threshold δ1, the notification controller 158 is configured to make the display device 3 report the control content for controlling the window opening/closing device 211 to close the window 811, and the control content for turning on the air conditioner 24.

In the home presence mode, because the window 811 that needs to be opened and closed changes according to an presence position of a person in the dwelling unit 8, the notification controller 158 is configured to make the display device 3 also report the place of the window 811 that needs to be opened and closed in addition to the control content. Because the air conditioner 24 that needs to be turned on and off changes according to a place at which a person exists, the notification controller 158 is configured to make the display device 3 also report the place of the air conditioner 24 that needs to be turned on and off in addition to the control content.

Incidentally, the storage unit 14 is configured to store also various kinds of information if necessary in addition to the history of the weather information, the history of the indoor environmental information, the control log, and the control information.

The storage unit 14 is configured to store a program for causing the air conditioning management device (computer) 1 to perform various functions. That is, the storage unit 14 is configured to store a program(s) that causes the air conditioning management device 1 to function as the first determining unit 151, the second determining unit 152, the third determining unit 153, the fourth determining unit 154, the selecting unit 155, the air-conditioning controller 157, and the notification controller 158. The program is preliminarily stored in the storage unit 14 at the time of shipment of the air conditioning management device 1. However, when the air conditioning management device 1 acquires the program after the shipment, as an example of the technique with which the air conditioning management device 1 acquires the program, there is a technique using the computer-readable recording medium that stores the program. In the case of the technique using the computer-readable recording medium, the air conditioning management device 1 needs only to include a reader (not shown) for reading data in the recording medium. Examples of the recording medium include an optical disc and a memory card. Examples of the reader include a drive device configured to read out information on the optical disc, and a memory card reader configured to read out information on the memory card. As another technique with which the air conditioning management device 1 acquires the program, there is a technique with which the air conditioning management device 1 downloads the program from another device (for example, server) other than the air conditioning management device 1 through a network. In the case of the technique of downloading the program, the air conditioning management device 1 needs only to have a communication function for communicating with the above-mentioned other device through the network.

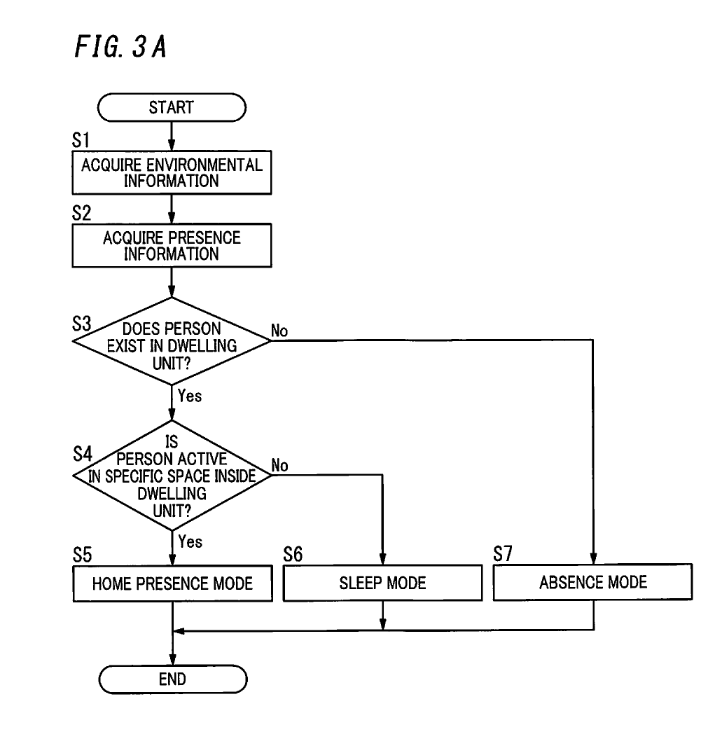

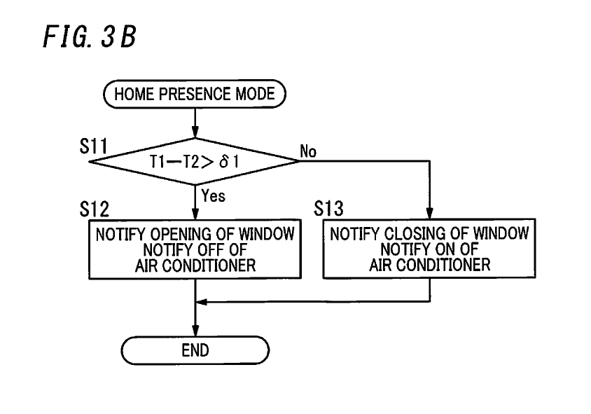

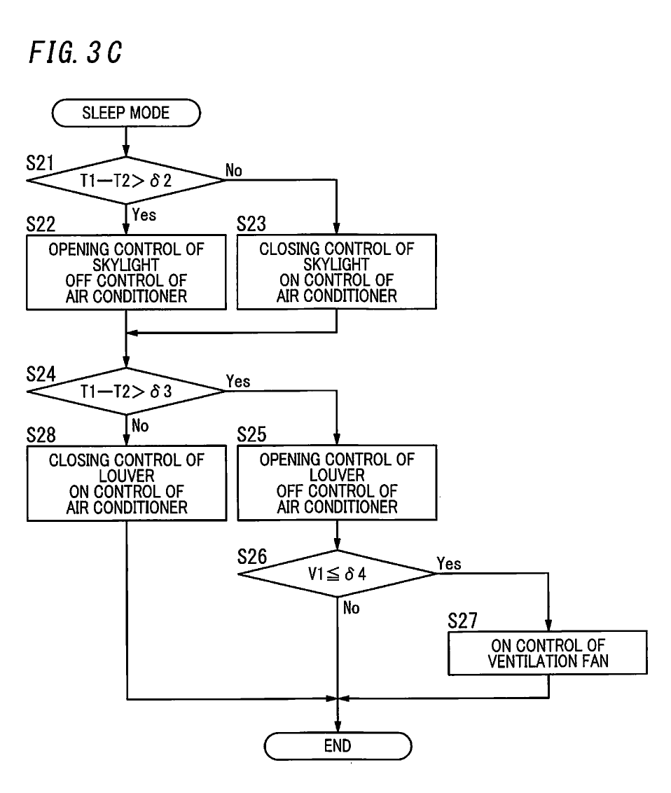

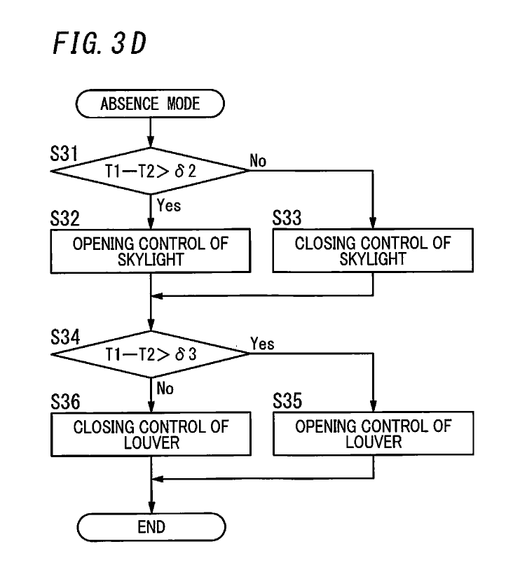

Next, an air conditioning management method with the air conditioning management device 1 according to the present embodiment will be described with reference to FIGS. 3A to 3D. The air conditioning management method is performed by executing the program stored in the storage unit 14 of the air conditioning management device 1.

First, as shown in FIG. 3A, the information acquisition unit 11 acquires the environmental information (S1). Then, the presence-information acquisition unit 13 acquires the presence information (S2). In the arithmetic processor 15, the first determining unit 151 determines whether or not a person exists in the dwelling unit 8 based on the presence information acquired in step S2 (S3).

When a person exists in the dwelling unit 8 (Yes at S3), the second determining unit 152 determines whether or not a person is active in the specific space 82 inside the dwelling unit 8 (S4). When a person is active in the specific space 82 (Yes at S4), the arithmetic processor 15 executes the home presence mode (S5). As shown in FIG. 3B, first, the third determining unit 153 determines whether or not the difference (T1−T2) obtained by subtracting the outside air temperature T2 from the room temperature T1 is more than the first threshold δ1 based on the environmental information acquired in step S1 (S11). When the difference (T1−T2) is more than the first threshold δ1 (Yes at S11), the notification controller 158 controls the display device 3 to report that the window 811 needs to be opened and the air conditioner 24 needs to be turned off (S12). At this time, the notification controller 158 controls the display device 3 to also report the place of the window 811 that needs to be opened and the installed position of the air conditioner 24 that needs to be turned off. On the other hand, in step S11, when the difference (T1−T2) is equal to or less than the first threshold δ1 (No at S11), the notification controller 158 controls the display device 3 to report that the window 811 needs to be closed and the air conditioner 24 needs to be turned on (S13). In step S13, a user may preferably set whether or not the air-conditioning controller 157 turns on the air conditioner 24 automatically.

In step S4 shown in FIG. 3A, when no person is active in the specific space 82 (No at S4), the arithmetic processor 15 executes the sleep mode (S6). As shown in FIG. 3C, first, the third determining unit 153 determines whether or not the difference (T1−T2) obtained by subtracting the outside air temperature T2 from the room temperature T1 is more than the second threshold δ2 (S21). When the difference (T1−T2) is more than the second threshold δ2 (Yes at S21), the air-conditioning controller 157 makes the skylight 812 be opened and turns off the air conditioner 24 (S22). On the other hand, in step S21, when the difference (T1−T2) is equal to or less than the second threshold δ2 (No at S21), the air-conditioning controller 157 makes the skylight 812 be closed and turns on the air conditioner 24 (S23). After steps S22 and S23, the third determining unit 153 determines whether or not the difference (T1−T2) obtained by subtracting the outside air temperature T2 from the room temperature T1 is more than the third threshold δ3 (S24). When the difference (T1−T2) is more than the third threshold δ3 (Yes at S24), the air-conditioning controller 157 makes the louver 22 be opened and turns off the air conditioner 24 (S25). Further, the fourth determining unit 154 determines whether or not the wind speed V1 in the environmental information acquired in step S1 is equal to or less than the fourth threshold δ4 (S26). When the wind speed V1 is equal to or less than the fourth threshold δ4 (Yes at S26), the air-conditioning controller 157 turns on the ventilation fan 23 (S27). When the wind speed V1 is more than the fourth threshold δ4 (No at S26), the ventilation fan 23 is in the off state. On the other hand, in step S24, when the difference (T1−T2) is equal to or less than the third threshold δ3 (No at S24), the air-conditioning controller 157 makes the louver 22 be closed and turns on the air conditioner 24 (S28). The air-conditioning controller 157 may control the air conditioner 24 only in steps S25 and S28 so that on and off of the air conditioner 24 is not repeated at steps S22 and S23 and steps S25 and S28. In steps S23 and S28, a user may preferably set whether or not the air-conditioning controller 157 turns on the air conditioner 24 automatically.

In step S3 shown in FIG. 3A, when no person exists in the dwelling unit 8 (No at S3), the arithmetic processor 15 executes the absence mode (S7). As shown in FIG. 3D, first, the third determining unit 153 determines whether or not the difference (T1−T2) obtained by subtracting the outside air temperature T2 from the room temperature T1 is more than the second threshold δ2 based on the environmental information acquired in step S1 (S31). When the difference (T1−T2) is more than the second threshold δ2 (Yes at S31), the air-conditioning controller 157 makes the skylight 812 to be opened (S32). On the other hand, in step S31, when the difference (T1−T2) is equal to or less than the second threshold δ2 (No at S31), the air-conditioning controller 157 makes the skylight 812 to be closed (S33). The third determining unit 153 determines, after steps S32 and S33, whether or not the difference (T1−T2) obtained by subtracting the outside air temperature T2 from the room temperature T1 is more than the third threshold δ3 (S34). When the difference (T1−T2) is more than the third threshold δ3 (Yes at S34), the air-conditioning controller 157 makes the louver 22 to be opened (S35). On the other hand, in step S34, when the difference (T1−T2) is equal to or less than the third threshold δ3 (No at S34), the air-conditioning controller 157 makes the louver 22 to be closed (S36).

The air conditioning management device 1 according to the present embodiment described above is configured to control the air conditioning adjustment system 2 to manage air-conditioning in the building (dwelling unit 8). The air conditioning adjustment system 2 is disposed in the building and configured to adjust air in the building. The air conditioning management device 1 includes the storage unit 14, the selecting unit 155, and the execution unit 156. The storage unit 14 is configured to store the first control content and the second control content as the control content for operating the air conditioning adjustment system 2. The first control content corresponds to the first scene in which no person is active in the predetermined specific space 82 inside the building. The second control content corresponds to the second scene in which a person is active in the predetermined specific space 82. The selecting unit 155 is configured to alternatively select the first scene or the second scene. The execution unit 156 is configured to execute the operational mode of operating the air conditioning adjustment system 2 according to the first control content stored in the storage unit 14 when the first scene is selected by the selecting unit 155. The execution unit 156 is configured to execute the notification mode of making the notification unit (display device 3) report the second control content stored in the storage unit 14 when the second scene is selected by the selecting unit 155.

The air conditioning system according to the present embodiment includes: the air conditioning management device 1; and the air conditioning adjustment system 2 that is the object to be controlled by the air conditioning management device 1.

The program according to the present embodiment is a program for executing the computer that is used in order to control the air conditioning adjustment system 2 to manage air-conditioning in the building (dwelling unit 8). The program causes the computer to function as the storage unit 14, the selecting unit 155, and the execution unit 156. The air conditioning adjustment system 2 is disposed in the building and configured to adjust air in the building. The storage unit 14 is configured to store the first control content and the second control content as the control content for operating the air conditioning adjustment system 2. The first control content corresponds to the first scene in which no person is active in the predetermined specific space 82 inside the building. The second control content corresponds to the second scene in which a person is active in the specific space 82. The selecting unit 155 is configured to alternatively select the first scene or the second scene. The execution unit 156 is configured to execute the operational mode of operating the air conditioning adjustment system 2 according to the first control content stored in the storage unit 14 when the first scene is selected by the selecting unit 155. The execution unit 156 is configured to execute the notification mode of making the notification unit (display device 3) report the second control content stored in the storage unit 14 when the second scene is selected by the selecting unit 155.

In the air conditioning system according to the present embodiment, the air conditioning management device 1 is configured to execute the operational mode of operating the air conditioning adjustment system 2 according to the first control content. The first control content corresponds to the first scene in which no person is active in the specific space 82 inside the dwelling unit (building) 8. On the other hand, the air conditioning management device 1 is configured to execute the notification mode of making the display device 3 as the notification unit report the second control content. The second control content corresponds to the second scene in which a person is active in the specific space 82. Therefore, according to the air conditioning management device 1, in the scene in which no person is active in the specific space 82 inside the dwelling unit (building) 8 when a person is absent, for example, it is possible to set air-conditioning so as to be an ideal state by automatic control and gain ideal air quality and ideal temperature. On the other hand, according to the air conditioning management device 1 according to the present embodiment, in the scene in which a person is active in the specific space 82 inside the dwelling unit 8, it is possible to prevent air quality and temperature from making a person in the dwelling unit 8 uncomfortable due to automatic control, and a person in the dwelling unit 8 can receive a support for performing air-conditioning.

The selecting unit 155 is preferably configured to select, as the first scene, the absence scene in which no person exists in the building (dwelling unit 8), or the sleep scene in which a person is sleeping in the building.

The selecting unit 155 is more preferably configured to select, as the second scene, the home presence scene in which a person exists and is active in the building (dwelling unit 8).

The air conditioning adjustment system 2 preferably includes the window opening/closing device 211 and the air conditioner 24. The window opening/closing device 211 is configured to control opening or closing of the window 811 disposed in the building (dwelling unit 8). The air conditioner 24 is configured to perform air-conditioning in the predetermined space inside the building. The storage unit 14 is configured to store, as the second control content, the control content about opening and closing of the window 811 and on and off of the air conditioner 24.

The air conditioning adjustment system 2 preferably includes the skylight opening/closing device 212, the louver 22, and the ventilation fan 23. The skylight opening/closing device 212 is configured to control opening or closing of the skylight 812 disposed in the building (dwelling unit 8). The louver 22 is disposed in the building. The ventilation fan 23 is configured to send air into the building from the outside of the building. The storage unit 14 is configured to store, as the first control content, the control content about opening and closing of the skylight 812, opening and closing of the louver 22, and on and off of the ventilation fan 23.

More preferably, the air conditioning management device 1 further includes the information acquisition unit 11. The information acquisition unit 11 is configured to acquire the room-temperature information indicating the room temperature T1 in the building (dwelling unit 8), and the outside-air-temperature information indicating the outside air temperature T2 outside the building. The execution unit 156 is configured to control the skylight opening/closing device 212, in the operational mode, so that the skylight 812 is opened when the difference (T1−T2) obtained by subtracting the outside air temperature T2 from the room temperature T1 is more than the predetermined threshold (second threshold δ2).

More preferably, the air conditioning management device 1 further includes the information acquisition unit 11. The information acquisition unit 11 is configured to acquire: the room information indicating the room temperature T1 in the building (dwelling unit 8); the outside air temperature T2 outside the building; and the wind speed information indicating the wind speed V1 outside the building. The execution unit 156 is configured to operate the ventilation fan 23, in the operational mode, when the wind speed V1 outside the building is equal to or less than the set value (fourth threshold δ4) while the difference (T1−T2) obtained by subtracting the outside air temperature T2 from the room temperature T1 is more than the predetermined threshold (third threshold δ3).

In the air conditioning system according to the present embodiment, when the difference (T1−T2) obtained by subtracting the outside air temperature T2 from the room temperature T1 is equal to or more than the threshold (third threshold δ3) and the wind speed V1 is equal to or less than the set value (fourth threshold δ4) in the operational mode, the air conditioning management device 1 operates the ventilation fan 23. Therefore, in the air conditioning management device 1 of the present embodiment, since the wind can be forcibly sent in the dwelling unit 8 with the ventilation fan 23 even in the state of being hard to send the wind into the dwelling unit 8 from the outside of the dwelling unit 8, air quality and temperature can be made to improve.

The air conditioning adjustment system 2 preferably includes the louver 22 and the air conditioner 24. The louver 22 is disposed in the building (dwelling unit 8). The air conditioner 24 is configured to perform air-conditioning in the predetermined space inside the building. The execution unit 156 is configured to close the louver 22 when the air conditioner 24 is in the on state. The execution unit 156 is configured to control the louver 22 to open when the air conditioner 24 is in the off state.

Preferably, the air conditioning management device 1 further includes the presence-information acquisition unit 13. The presence-information acquisition unit 13 is configured to acquire the presence information indicating whether or not a person exists in the building (the dwelling unit 8). The selecting unit 155 is configured to alternatively select the first scene or the second scene based on the presence-information acquired by the presence-information acquisition unit 13.

Preferably, the air conditioning management device 1 further includes the presence-information acquisition unit 13, the first determining unit 151, and the second determining unit 152. The selecting unit 155 is preferably configured to perform the following operations. The presence-information acquisition unit 13 is configured to acquire the presence information indicating whether or not a person exists in the building (dwelling unit 8). The first determining unit 151 is configured to determine whether or not a person exists in the building based on the presence information acquired by the presence-information acquisition unit 13. The second determining unit 152 is configured to determine whether or not a person is active in the specific space 82 inside the building based on the presence information acquired by the presence-information acquisition unit 13 when the first determining unit 151 determines that a person exists in the building. The selecting unit 155 is configured to select the absence scene when the first determining unit 151 determines that no person exists in the building. The selecting unit 155 is configured to select the sleep scene when the second determining unit 152 determines that no person is active in the specific space 82 inside the building. The selecting unit 155 is configured to select the home presence scene when the second determining unit 152 determines that a person is active in the specific space 82 inside the building.

In the present embodiment, the first acquisition unit 111 of the information acquisition unit 11 is configured to acquire the wind pertinent information from the anemometer 4. However, as a modification of the present embodiment, the first acquisition unit 111 may be configured to acquire the wind pertinent information from an external device (not shown). The external device needs to be, for example, a device configured to acquire the wind pertinent information directly or indirectly from a measuring device such as the anemometer 4 and hold the wind pertinent information, periodically.

In the present embodiment, the second acquisition unit 112 of the information acquisition unit 11 is configured to acquire the outside air temperature and the outside air humidity from the first thermo-hygrometer 5 installed outside the dwelling unit (building) 8. However, as a modification of the present embodiment, the second acquisition unit 112 may be configured to acquire the outside air temperature and the outside air humidity from an external device (not shown). The external device needs to be, for example, a device configured to acquire the outside air temperature and the outside air humidity directly or indirectly from a measuring device such as the first thermo-hygrometer 5 and hold the outside air temperature and the outside air humidity, periodically.

In the present embodiment, the third acquisition unit 113 of the information acquisition unit 11 is configured to acquire the indoor environmental information from the second thermo-hygrometer 6 installed in the dwelling unit (building) 8. However, as a modification of the present embodiment, the third acquisition unit 113 may be configured to acquire the indoor environmental information from an external device (not shown). The external device may be, for example, a device configured to acquire the indoor environmental information directly or indirectly from the second thermo-hygrometer 6 and hold the indoor environmental information, periodically.

Further, in the present embodiment, the air-conditioning controller 157 may be configured to control the air conditioning adjustment system 2 directly, and may be configured to output the control content to a management device (not shown) configured to manage the air conditioning adjustment system 2. The management device may be configured to control the air conditioning adjustment system 2 according to the control content when acquiring the control content from the air-conditioning controller 157.

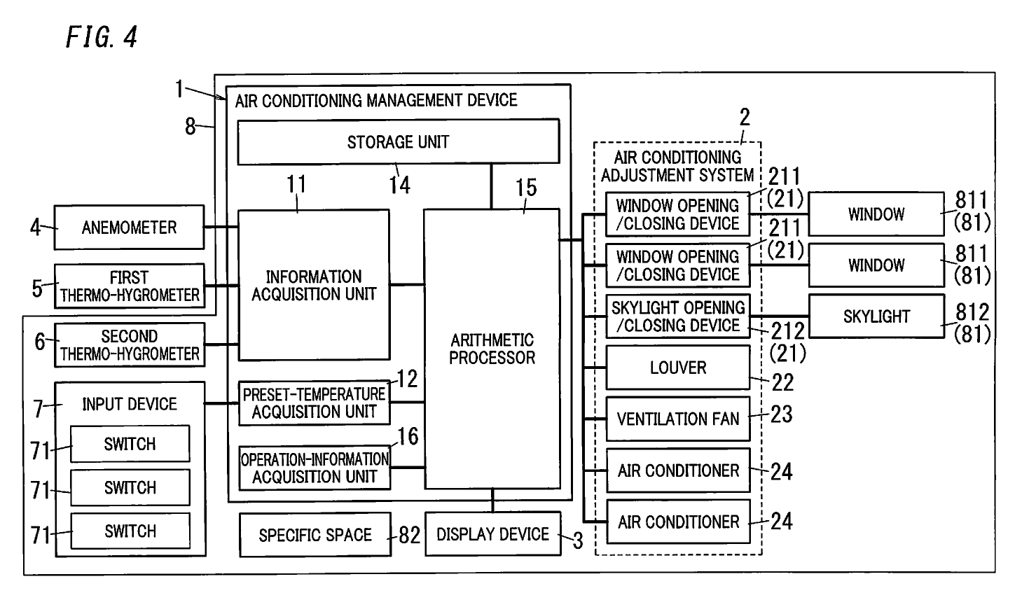

As a modification of the present embodiment, the selecting unit 155 may select the scene based on the operation performed to the input device 7, instead of selecting the scene according to the presence information. In the modification, as shown in FIG. 4, the input device 7 includes a plurality of switches 71 respectively corresponding to a plurality of scenes, and receives the operation to each switch 71. Then, when the operation for selecting the scene in the input device 7 is performed, the selecting unit 155 is configured to select the scene according to the operation information. When the operation for selecting the home presence scene in the input device 7 is performed, the selecting unit 155 selects the home presence scene. When the operation for selecting the sleep scene in the input device 7 is performed, the selecting unit 155 sets up the sleep scene. When the operation for selecting the absence scene in the input device 7 is performed, the selecting unit 155 is configured to select the absence scene.

In other words, preferably, the air conditioning management device 1 further includes the operation-information acquisition unit 16. The operation-information acquisition unit 16 is configured to acquire, from the input device 7, the operation information indicating the operation content to the input device 7. The input device 7 is configured to receive the operation for selecting the first scene or the second scene. The selecting unit 155 is configured to alternatively select the first scene or the second scene based on the operation information acquired by the operation-information acquisition unit 16.

Preferably, the air conditioning management device 1 further includes the operation-information acquisition unit 16. The operation-information acquisition unit 16 is configured to acquire, from the input device 7, the operation information indicating the operation content to the input device 7. The input device 7 is configured to receive the operation for selecting the absence scene, the sleep scene, or the home presence scene. The selecting unit 155 is configured to select the home presence scene when the input device 7 receives the operation for selecting the home presence scene. The selecting unit 155 is configured to select the sleep scene when the input device 7 receives the operation for selecting the sleep scene. The selecting unit 155 is configured to select the absence scene when the input device 7 receives the operation for selecting the absence scene.

The air conditioning management device 1 may have both of a function of selecting a scene based on the presence information and a function of selecting a scene based on the operation information. Alternatively, the air conditioning management device 1 may have only the function of selecting the scene based on the operation information.

As shown in FIG. 1B, the air conditioning adjustment system 2 may include the plurality of apparatuses. Alternatively, the air conditioning adjustment system 2 may include only a single apparatus.

Although the present invention has been described with reference to a certain preferred embodiment, numerous modifications and variations can be made by those skilled in the art without departing from the true spirit and scope of this invention, namely claims.

1. An air conditioning management device configured to control an air conditioning adjustment system to manage air-conditioning in the building, the air conditioning adjustment system being disposed in a building and configured to adjust air in the building, the air conditioning management device comprising:
a storage unit configured to store a first control content and a second control content as a control content for operating the air conditioning adjustment system, the first control content corresponding to a first scene in which no person is active in a predetermined specific space inside the building, the second control content corresponding to a second scene in which a person is active in the predetermined specific space;
a selecting unit configured to alternatively select the first scene or the second scene; and
an execution unit configured to execute an operational mode of operating the air conditioning adjustment system according to the first control content stored in the storage unit when the first scene is selected by the selecting unit, the execution unit being configured to execute a notification mode of making a notification unit report the second control content stored in the storage unit when the second scene is selected by the selecting unit.

2. The air conditioning management device according to claim 1, wherein the selecting unit is configured to select, as the first scene, an absence scene in which no person exists in the building, or a sleep scene in which a person is sleeping in the building.

3. The air conditioning management device according to claim 2, wherein the selecting unit is configured to select, as the second scene, a home presence scene in which a person exists and is active in the building.

4. The air conditioning management device according to claim 1,
wherein the air conditioning adjustment system comprises:
a window opening/closing device configured to control opening or closing of a window disposed in the building; and
an air conditioner configured to perform air-conditioning in a predetermined space inside the building, and
wherein the storage unit is configured to store, as the second control content, a control content about opening and closing of the window and on and off of the air conditioner.

5. The air conditioning management device according to claim 1,
wherein the air conditioning adjustment system comprises:
a skylight opening/closing device configured to control opening or closing of a skylight disposed in the building;
a louver disposed in the building; and
a ventilation fan configured to send air into the building from an outside of the building,
wherein the storage unit is configured to store, as the first content, a control content about opening and closing of the skylight, opening and closing of the louver, and on and off of the ventilation fan.

6. The air conditioning management device according to claim 5, further comprising an information acquisition unit configured to acquire room-temperature information indicating a room temperature in the building, and outside-air-temperature information indicating outside air temperature outside the building,
wherein the execution unit is configured to control the skylight opening/closing device, in the operational mode, so that the skylight is opened when a difference obtained by subtracting the outside air temperature from the room temperature is more than a predetermined threshold.

7. The air conditioning management device according to claim 5, further comprising an information acquisition unit configured to acquire: room information indicating room temperature in the building; outside air temperature outside the building; and wind speed information indicating wind speed outside the building,
wherein the execution unit is configured to operate the ventilation fan, in the operational mode, when the wind speed outside the building is equal to or less than a set value while a difference obtained by subtracting the outside air temperature from the room temperature is more than a predetermined threshold.

8. The air conditioning management device according to claim 1,
wherein the air conditioning adjustment system comprises:
a louver disposed in the building; and
an air conditioner configured to perform air-conditioning in a predetermined space inside the building,
wherein the execution unit is configured to make the louver close when the air conditioner is in an on state,
the execution unit being configured to make the louver open when the air conditioner is in an off state.

9. The air conditioning management device according to claim 1, further comprising a presence-information acquisition unit configured to acquire presence information indicating whether or not a person exists in the building,
wherein the selecting unit is configured to alternatively select the first scene or the second scene based on the presence information acquired by the presence-information acquisition unit.

10. The air conditioning management device according to claim 1, further comprising an operation-information acquisition unit configured to acquire, from an input device, operation information indicating an operation content to the input device, the input device being configured to receive an operation for selecting the first scene or the second scene,
wherein the selecting unit is configured to alternatively select the first scene or the second scene based on the operation information acquired by the operation-information acquisition unit.

11. The air conditioning management device according to claim 3, further comprising:
a presence-information acquisition unit configured to acquire presence information indicating whether or not a person exists in the building;
a first determining unit configured to determine whether or not a person exists in the building based on the presence information acquired by the presence-information acquisition unit; and
a second determining unit configured to determine whether or not a person is active in the predetermined specific space inside the building based on the presence information acquired by the presence-information acquisition unit when the first determining unit determines that a person exists in the building,
wherein the selecting unit is configured to select the absence scene when the first determining unit determines that no person exists in the building,
the selecting unit being configured to select the sleep scene when the second determining unit determines that no person is active in the predetermined specific space inside the building,
the selecting unit being configured to select the home presence scene when the second determining unit determines that a person is active in the predetermined specific space inside the building.

12. The air conditioning management device according to claim 3, further comprising an operation-information acquisition unit configured to acquire, from an input device, operation information indicating an operation content to the input device, the input device being configured to receive an operation for selecting the absence scene, the sleep scene, or the home presence scene,
wherein the selecting unit is configured to select the home presence scene when the input device receives an operation for selecting the home presence scene,
the selecting unit being configured to select the sleep scene when the input device receives an operation for selecting the sleep scene,
the selecting unit being configured to select the absence scene when the input device receives an operation for selecting the absence scene.

13. An air conditioning system comprising:
the air conditioning management device according to claim 1; and
the air conditioning adjustment system that is an object to be controlled by the air conditioning management device.

14. A computer-readable recording medium recording a program for executing a computer that is used in order to control an air conditioning adjustment system to manage air-conditioning in the building, the air conditioning adjustment system being disposed in a building and configured to adjust air in the building, the program causing the computer to function as:
a storage unit configured to store a first control content and a second control content as a control content for operating the air conditioning adjustment system, the first control content corresponding to a first scene in which no person is active in a predetermined specific space inside the building, the second control content corresponding to a second scene in which a person is active in the predetermined specific space;
a selecting unit configured to alternatively select the first scene or the second scene; and
an execution unit configured to execute an operational mode of operating the air conditioning adjustment system according to the first control content stored in the storage unit when the first scene is selected by the selecting unit, the execution unit being configured to execute a notification mode of making a notification unit report the second control content stored in the storage unit when the second scene is selected by the selecting unit.

15. The air conditioning management device according to claim 2,
wherein the air conditioning adjustment system comprises:
a window opening/closing device configured to control opening or closing of a window disposed in the building; and
an air conditioner configured to perform air-conditioning in a predetermined space inside the building, and
wherein the storage unit is configured to store, as the second control content, a control content about opening and closing of the window and on and off of the air conditioner.

16. The air conditioning management device according to claim 3,
wherein the air conditioning adjustment system comprises:
a window opening/closing device configured to control opening or closing of a window disposed in the building; and
an air conditioner configured to perform air-conditioning in a predetermined space inside the building, and
wherein the storage unit is configured to store, as the second control content, a control content about opening and closing of the window and on and off of the air conditioner.

17. The air conditioning management device according to claim 2,
wherein the air conditioning adjustment system comprises:
a skylight opening/closing device configured to control opening or closing of a skylight disposed in the building;
a louver disposed in the building; and
a ventilation fan configured to send air into the building from an outside of the building,
wherein the storage unit is configured to store, as the first content, a control content about opening and closing of the skylight, opening and closing of the louver, and on and off of the ventilation fan.

18. The air conditioning management device according to claim 3,
wherein the air conditioning adjustment system comprises:
a skylight opening/closing device configured to control opening or closing of a skylight disposed in the building;
a louver disposed in the building; and
a ventilation fan configured to send air into the building from an outside of the building,
wherein the storage unit is configured to store, as the first content, a control content about opening and closing of the skylight, opening and closing of the louver, and on and off of the ventilation fan.

19. The air conditioning management device according to claim 2,
wherein the air conditioning adjustment system comprises:
a louver disposed in the building; and
an air conditioner configured to perform air-conditioning in a predetermined space inside the building,
wherein the execution unit is configured to make the louver close when the air conditioner is in an on state,
the execution unit being configured to make the louver open when the air conditioner is in an off state.

20. The air conditioning management device according to claim 3,
wherein the air conditioning adjustment system comprises:
a louver disposed in the building; and
an air conditioner configured to perform air-conditioning in a predetermined space inside the building,
wherein the execution unit is configured to make the louver close when the air conditioner is in an on state,
the execution unit being configured to make the louver open when the air conditioner is in an off state.
